(19) United States
(12) Patent Application Publication
(10) Pub. No.: US 2006/0053155 A1
(43) Pub. Date: Mar. 9, 2006

(54) Signature generating method, signature verifying method, and information processing device

(75) Inventor: Yuji Suga, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/202,491

(22) Filed: Aug. 12, 2005

(30) Foreign Application Priority Data
Aug. 24, 2004 (JP) 2004-244132

(51) Int. Cl. G06F 7/00

(52) U.S. Cl. 707/102

(57) ABSTRACT

A method and device for verifying content using signature data for the content, where the content includes dynamically changing information. The method and device include inputting content including dynamically changing information, obtaining at least one of an upper and a lower limit of the dynamically changing information, generating target data based on the at least one of the upper and lower limits, generating signature data by attaching a signature to the target data, and verifying the signature based on the target data. The content is then verified using the signature data.

### BACKGROUND OF THE INVENTION

1. Field of the Invention

The present invention relates to techniques for generating signature data for content, and verifying content by using the signature data.

2. Description of the Related Art

These days, there are an increasing number of occasions where digital content, including documents and image data, is distributed via high-speed data lines and large-capacity recording media, such as a digital versatile disk (DVD). In particular, in a digital-content distribution service, which is a content distribution service to specific users, it is required to provide a mechanism for preventing the leakage of content to unauthorized users. In a content distribution service via a large-capacity medium, the same kinds of user access control mechanisms have also been provided. Specifically, content data is encrypted or scrambled, and only authorized users, who have been given appropriate key information or informed of a descrambling process, can decrypt the content data and receive appropriate content such as documents and image data.

There are content providers that provide content distribution services as described above. It is generally assumed that such a content provider sets different access control information for each content, and performs encryption with keys that vary by content, by user, or by user action (such as viewing and copying). It is also assumed that a content owner may place certain restrictions on operations that can be performed on content by the content users. In particular, for the same operation, control information, such as the period of validity (for example, from Jan. 1, 2000 to Jan. 31, 2000) and the number of operations (for example, the user can print the content up to five times), is treated as numerical information. In this case, counter-related information, such as the maximum permissible number of operations and the permissible number of operations currently remaining, needs to be managed together with permission information.

The counter dynamically changes every time an operation (also called an action), such as printing and viewing, is performed on content. Limits of the counter (upper limit and lower limit) may be included in content itself or in access control information of the content.

To ensure the integrity of digital content, that is, in order for the receiver to detect whether or not received data has been substituted, a digital signature is attached to the content such that additional data for protection against substitution is verified. Such a digital signature technique provides protection against spoofing and denial-of-service attacks on the Internet, as well as protection against substitution of data.

As described above, in a method of control over digital content, counter information may be included in data to which a signature is to be attached (the data is also referred to as target data). In this case, signature verification fails due to counter updates. Therefore, information including the counter that changes dynamically every time processing is performed needs to be excluded from the range of the signature. However, if signature verification can be made regardless of the dynamic changes to the counter, the processes of the addition and verification of signatures become complex.

In other words, in a content-data-structure change system by which content is restructured such that data to which a signature is to be attached is integrated, counter limit information is associated with an operation performed on the content. If a plurality of operations on the content are defined and expressed by a list structure, counter limit information is inserted into “operation” elements in the list structure. This causes the target data to be dispersed. Thus, a problem arises in that the signing and verification of signatures become complex.

A simple method to avoid this problem is to apply a signature to every value that the counter can take, and select one of signature data to perform verification. However, due to the enormous volume of signature data in such a method, the amount of content information and the amount of calculation when a signature is attached increase.

As described above, the known digital signature system results in unsuccessful signature verification, even if only one bit of target data has been altered.

### SUMMARY OF THE INVENTION

The present invention has been made to solve the problems described above, and is directed to allow the verification of content using signature data for the content, even if the content includes dynamically changing information.

In a fist aspect of the present invention, a signature generating method includes an input step of inputting content including dynamically changing information; an obtaining step of obtaining at least one of an upper limit and a lower limit of the dynamically changing information; a target-data generating step of generating, based on the at least one of the upper limit and the lower limit, target data; and a signature generating step of generating signature data by attaching a signature to the target data. In another aspect of the present invention, a signature verifying method includes an input step of inputting content containing dynamically changing information, and inputting signature data for the content; an obtaining step of obtaining at least one of an upper limit and a lower limit of the dynamically changing information; a target-data forming step of forming, from the at least one of the upper limit and the lower limit, target data; and a signature verifying step of verifying the signature data based on the target data.

Further features of the present invention will become apparent from the following description of exemplary embodiments with reference to the attached drawings.

### BRIEF DESCRIPTION OF THE DRAWINGS

FIGS. 1A and 1B illustrate a signing process and a verifying process.

FIG. 2 illustrates an example of the structure of an information processing device in a first embodiment.

FIG. 3 is a flowchart showing a signing process in the first embodiment.

FIG. 4 is a flowchart showing a verifying process in the first embodiment.

### DESCRIPTION OF THE EMBODIMENTS

Embodiments of the present invention will now be described in detail with reference to the drawings.

Digital Signature

First, the outline of a digital signature will be described. A hash function and public key cryptosystem are used to generate digital signature data. The sender applies a hash function to input data M, obtains fixed-length data H(M), converts the fixed-length data H(M) with a private key Ks into digital signature data S, and sends the digital signature data S and the input data M to the recipient.

The recipient then verifies whether or not data obtained by converting (decrypting) the digital signature data S with a public key Kp matches the input data M to which the hash function has been applied. If they do not match, it is determined that the input data M has been altered.

Digital signatures use public key cryptosystems, such as RSA and DSA. The security of a digital signature is based on the fact that it is mathematically difficult for an entity other than the owner to forge a signature or decrypt a private key.

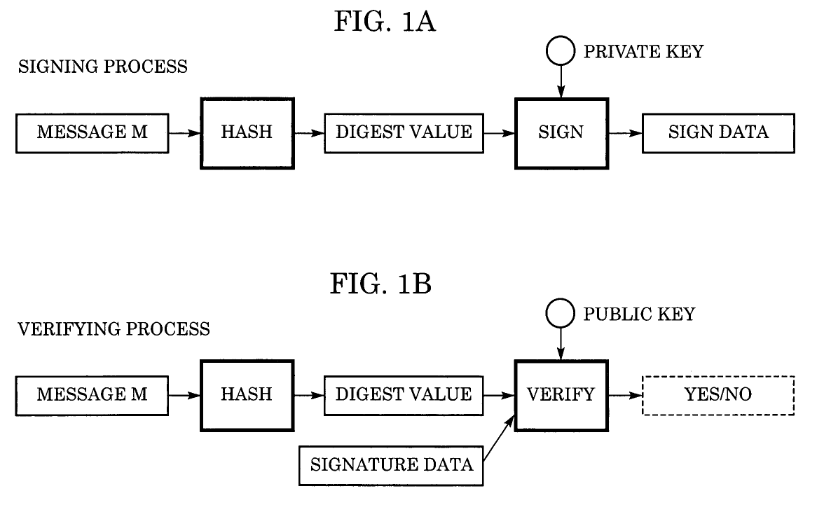

FIGS. 1A and 1B illustrate a signing process and a verifying process. As shown in FIGS. 1A and 1B, a signing process for generating digital signature data and a verifying process for verifying input data by using the digital signature data are performed, as described above.

Hash Function

A hash function used for accelerating the generation of digital signature data will now be described. When the hash function is applied to data M with a given length, a certain length of output data is generated. An output H(M) is here referred to as hash data of plaintext data M. Particularly in a one-way hash function, when data M is given, it is difficult due to the amount of calculation to determine plaintext data M′ which produces H(M′)=H(M). Examples of the one-way hash function include standard algorithms, such as MD2, MD5, and SHA-1, which are available to the public.

Public Key Cryptosystem

Public key cryptosystem will now be described. The public key cryptosystem is characterized in that it uses two different keys, and that data encrypted by one of the keys can be decrypted only by the other key. One of the two keys is called a public key, which is made publicly available. The other key is called a private key, which is kept secret and is known only by its owner.

Examples of digital signatures using the public key cryptosystem include a DSA signature scheme, an RSA signature scheme, and a Schnorr signature scheme. The DSA signature scheme will be described here as an example.

DSA Signature Scheme

A scheme described in the “Federal Information Processing Standards (FIPS) 186-2, Digital Signature Standard (DSS), January 2000” will now be described. When p and q represent primes, q is divisible by p-1. Letter g represents a generator of an order q arbitrarily selected from z_p* (multiplicative group obtained by excluding 0 from a cyclic group z_p of an order p). A private key x is arbitrarily selected from z_p* and its corresponding public key y is expressed as y=g^{x} mod p. H( ) represents a hash function.

DSA Signature Generation

The process of generating a signature for a document M is as follows:

1) Arbitrarily select α from z_q and set T:=(g^{α} mod p) mod q;

2) Set c:=H(M); and

3) Set s:=α⁻¹ (c+xT) mod q, and express signature data as (s, T).

DSA Signature Verification

To verify the signature data (s, T) for the document M, it is determined whether or not T=(g^{H(M)/s} y^{T/s} mod p) mod q is satisfied.

As described above, the digital signature technology provides protection against spoofing, substitution of data, and denial-of-service attacks on the Internet.

### First Embodiment

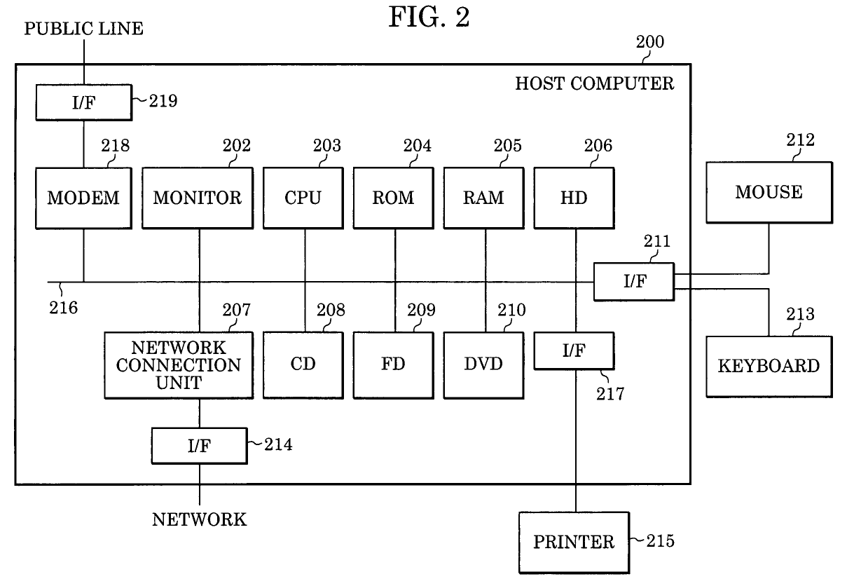

FIG. 2 illustrates an example of the structure of an information processing device 200 in the first embodiment. All of the functions depicted in FIG. 2 are not always necessary for implementing the present invention.

The information processing device 200 includes a modem 218, a monitor 202, a central processing unit (CPU) 203, a read-only memory (ROM) 204, a random-access memory (RAM) 205, a hard disk (HD) 206, a network connection unit 207, a compact disk (CD) 208, a floppy disk (FD) 209, a digital video disk or digital versatile disk (DVD) 210, an interface (I/F) 217 to a printer 215, and an I/F 211 to an operation unit, including a mouse 212 and a keyboard 213. These components of the information processing device 200 are connected via a bus 216 in a manner such that they can communicate with one another. Each of these components will now be described.

The mouse 212 and the keyboard 213 constitute an operation unit that allows a user to input various instructions to the information processing device 200. Information is inputted via the operation unit (operation information) and the I/F 211 into the information processing device 200.

Various information, such as textual information and image information, in the information processing device 200 is configured to be outputted to the printer 215.

The monitor 202 displays various information, such as instructions to the user, textural information, and image information.

The CPU 203 controls the overall operations of the information processing device 200 and serves as a control unit in the first embodiment. Specifically, the CPU 203 reads a processing program (software program) from the HD 206 or the like, and executes it, thereby controlling the entire information processing device 200.

In the first embodiment, the CPU 203 reads, from the HD 206 or the like, and executes a processing program for implementing a signature generating function and a signature verifying function, thereby performing an information conversion process, which will be detailed below.

The ROM 204 stores a system boot program, various processing programs, or control data.

The RAM 205 serves as a work area, for various processing in the CPU 203, for temporarily storing a processing program and information to be processed.

The HD 206 is a component serving as an example of a large-capacity storage. The HD 206 stores various data or processing programs for the conversion of information and the like. The processing programs are to be transferred to the RAM 205 or the like for the execution of various processing.

The CD (CD drive) 208 has a function of reading data stored in a CD (CD recordable (CD-R)), which serves as an example of external storage, and writing data on the CD.

Similarly to the CD 208 described above, the FD (FD drive) 209 has a function of reading data stored in an FD, which serves as an example of external storage, and writing various data on the FD.

Similarly to the CD 208 and FD 209 described above, the DVD (DVD drive) 210 has a function of reading data stored in a DVD, which serves as an example of external storage, and writing data on the DVD.

If an editing program or a printer driver is stored in external storage, such as the CD 208, FD 209, and DVD 210 described above, such a program or the like may be installed in the HD 206 and transferred to the RAM 205 if required.

The I/F 211 accepts inputs from the user via the mouse 212 or the keyboard 213.

The modem 218 is a communication modem for communicating, via an I/F 219, with communication apparatuses connected to an external communication network via, for example, a public line.

The network connection unit 207 controls, via an I/F 214, connection to a network, such as a LAN.

A signing process for generating a signature for content and content access control information, and a verifying process for the signature, which are both performed in the information processing device 200, will be described below.

Signature Generation

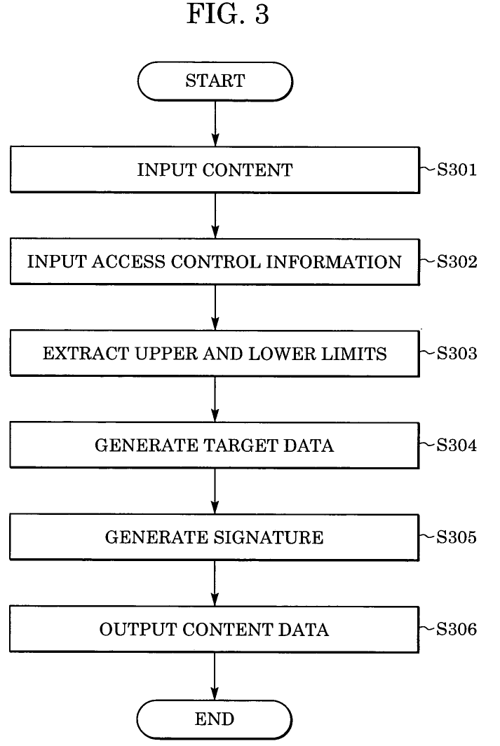

FIG. 3 is a flowchart showing a signing process in the first embodiment. In response to inputs from the information processing device 200, specifically from the mouse 212 and the keyboard 213 in FIG. 2, the CPU 203 and the like executes a predetermined program stored in the HD 206 or the like, thereby implementing this process.

In step S301, content C to be protected is inputted. In step S302, access control information DR_C for the content C inputted in step S301 is inputted.

The access control information DR_C includes numerical data, such as the period of validity (e.g., from Jan. 1, 2000 to Jan. 31, 2000) and the number of operations (e.g., the user can print content up to five times), that dynamically changes every time the user performs an operation. An example of the access control information DR_C described in the extensible markup language (XML) will be detailed below.

In step S303, the lower limit and upper limit of the numerical data are extracted from the access control information DR_C inputted in step S302. That is, since the numerical data included in the access control information DR_C is limited to a specific range, the lower and upper limits of every item of numerical data are extracted.

In step S304, two items of target data, that is, access control information DATA_U in which all items of numerical data are set to the upper limits and access control information DATA_L in which all items of numerical data are set to the lower limits, are generated. In step S305, the target data generated in step S304 is coupled to the content C as follows to generate digital signature data S using a known algorithm, such as a public key cryptosystem.

C∥DATA_U∥DATA_L

Although the symbol “∥” represents the coupling of data, the data can be structured in any manner.

Finally in step S306, the content C inputted in step S301, the access control information DR_C inputted in step S302, and the signature data S generated in step S305 are combined together and outputted as newly formatted content data P.

Referring to FIG. 1A, in the signing process described above, the hash function is not applied to the original message M, but to the message M after the conversion process (which involves the generation of target data and coupling to the content). The conversion process corresponds to step S304, and the generation of signature data corresponds to step S305.

The following is an example of the content C and access control information DR_C described in XML.

```
<mdf>
  <contents>
    <binary_embeded type=“base64” id=“image1”>
      deadbeef...
    </binary_embeded>
  </contents>
  <contents_condition>
    <target ref=“#image1”>
      <conditions>
        <print>
          <amount upper=“5”>0</amount>
        </print>
      </conditions>
    </target>
  </contents_condition>
</mdf>
```

As described above, the “mdf” element contains the “contents” element (corresponding to the content C) and the “contents_condition” element (corresponding to the access control information DR_C). In the “contents” element, base64-encoded image data with an id “image1” is embedded. Access control information for the image data “image1” contains a quota on printing. As described in the “upper” attribute, the number of print operations is limited to five times. The “amount” element contains a number indicating the current number of print operations. While the initial value 0 is given in the example above, the number is a counter that dynamically changes and is incremented by one every time a print operation is performed. Therefore, if a signature is attached to the entire “mdf” element, the signature verification fails due to counter updates.

Therefore, in the first embodiment, the target data DATA_U and DATA_L will be described as follows:

DATA_U:

```
  </contents_condition>
    <target ref=“#image1”>
      <conditions>
        <print>
          <amount>5</amount>
        </print>
      </conditions>
    </target>
    </contents_condition>
DATA_L:
  <contents_condition>
    <target ref=“#image1”>
      <conditions>
        <print>
          <amount>0</amount>
        </print>
      </conditions>
    </target>
  </contents_condition>
```

In the description above, the “amount” element in the target data DATA_U contains the upper limit “5”, and the “amount” element in the target data DATA_L contains the lower limit “0”. The target data indicating the upper limit and lower limit may be combined together and expressed as follows:

DATA_(U+L):

```
<contents_condition>
  <target ref=“#image1”>
    <conditions>
      <print>
        <amount>lower=“0” upper=“5”</amount>
      </print>
    </conditions>
  </target>
</contents_condition>
```

Signature Verification

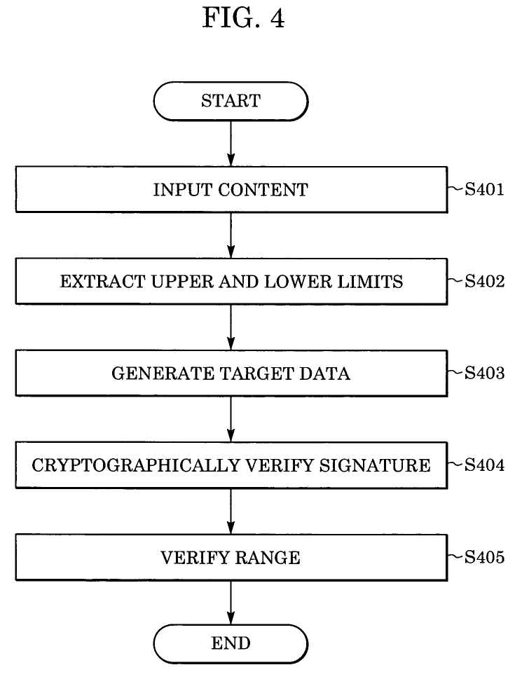

Referring to FIG. 4, a verifying process for verifying the signature data generated in the above-described signing process will now be described.

FIG. 4 is a flowchart showing the verifying process in the first embodiment. In response to inputs from the information processing device 200, specifically from the mouse 212 and the keyboard 213 in FIG. 2, the CPU 203 and the like executes a predetermined program stored in the HD 206 or the like, thereby implementing this process.

In step S401, the content data P including the access control information is inputted. In step S402, similarly to the step S303 in the signing process described above, the lower limit and upper limit are extracted from the access control information inputted in step S401. In step S403, similarly to the step S304 described above, two items of target data, that is, access control information DATA_U in which all items of numerical data are set to the upper limits and access control information DATA_L in which all items of numerical data are set to the lower limits, are generated. In step S404, the target data generated in step S403 is coupled to the content as follows to cryptographically verify the content using the signature data S.

C∥DATA_U∥DATA_L

Finally in step S405, verification is performed to determine whether the numerical data to be controlled falls within the range between the upper and lower limits.

For example, the following data will be verified.

```
<mdf>
  <contents>
    <binary_embeded type=“base64” id=“image1”>
      deadbeef...
    </binary_embedded>
  </contents>
  <contents_condition>
    <target ref=“#image1”>
      <conditions>
        <print>
          <amount upper=“5”>2</amount>
        </print>
      </conditions>
    </target>
  </contents_condition>
  <signature>...</signature>
</mdf>
```

Since the number of print operations “2” in the above-described “amount” element falls within the range between the upper limit “5” and the lower limit “0”, the range verification in step S405 indicates that the data is valid. The “signature” element contains a signature for the entire “mdf” element. This adheres to the Enveloped Signature scheme in the XML Signature in the W3C standard. Interoperability can be ensured when the verifying process in the first embodiment is described in a “transform” element in the “signature” element.

According to the first embodiment, signature data can be generated from access control information containing dynamically changing numerical data, and content can be verified using the signature data.

### Second Embodiment

The second embodiment of the present invention will now be described in detail. The structure of the information processing device in the second embodiment will not be described here, as it is the same as that described in the first embodiment with reference to FIG. 2.

The first embodiment deals with a signature for a single item of numerical data. The following example will show that a plurality of pieces of numerical data can also be processed.

```
<mdf>
  <contents>
    <binary_embeded type=“base64” id=“image1”>
      deadbeef...
    </binary_embedded>
  </contents>
  <contents_condition>
    <target ref=“#image1”>
      <conditions>
        <print>
          <amount upper=“5”>0</amount>
        </print>
        <display>
          <time lower=“2000-01-01-0900” upper=“2000-01-31-2100”>
            #include-time
          </time>
        </display>
      </conditions>
    </target>
  </contents_condition>
  <signature>...</signature>
</mdf>
```

In the example above, the “amount” element (i.e. quota on printing) in the “print” element and the “time” element (i.e. time limit on a display operation) in the “display” element are described. In this case, DATA_U and DATA_L will be described as follows:

```
DATA_U:
</contents_condition>
    <target ref=“#image1”>
      <conditions>
        <print>
          <amount>5</amount>
        <print>
        <display>
          <time>2000-01-01-0900</time>
        </display>
      </conditions>
    </target>
  </contents_condition>
DATA_L:
<contents_condition>
    <target ref=“#image1”>
      <conditions>
        <print>
          <amount>0</amount>
        </print>
        <display>
          <time>2000-01-31-2100</time>
        </display>
      </conditions>
    </target>
  </contents_condition>
```

While the verifying process of the second embodiment is basically the same as that of the first embodiment, “#include-time” contained in the “time” element in the “display” element of the content data P indicates that this part is replaced with the current time of the system to verify the data.

While counter information is contained within the content in the example described above, the counter information may be downloaded from the system or other resources. In particular, in the case where a ticket for using content is downloaded from a content management server, numerical data of the content may be interactively downloaded for using the content and checked for the verification of the content.

The numerical data may be inseparably included in the content, for example, using a digital watermark. In this case, access control information, instead of counter information, may be included in the content using the digital watermark.

According to the first and second embodiments, signature data for content containing dynamically changing information can be generated, and the content can be verified using the signature data.

### Other Embodiments

Although both the upper and lower limits are given in the embodiments described above, it is obvious that the present invention is equally applicable to the case where only the upper or lower limit is given. Further, in the case where the counter information increases (i.e., where the counter information increases by one whenever an apparatus prints), only the lower limit(s) should be given. On the other hand, in the case where the counter information decreases, only the upper limit(s) should be given.

The present invention may be applicable not only to a part of a system composed of a plurality of apparatuses (e.g., a host computer, interface apparatus, reader, and printer), but also to a part of an apparatus (e.g., a copier and facsimile).

The scope of the present invention is not limited to a device and method for implementing the above-described embodiments, and to the combination of the methods described in the embodiments. The scope of the present invention further includes the case where a software program code for implementing the embodiments is supplied to a computer (or CPU or micro-processing unit (MPU)) of the above-described system or device, so that the computer of the system or device causes the above-described various components to operate according to the program code, thereby implementing the embodiments described above.

Since in this case the software program code itself implements the functions of the embodiments, the program code and a unit for supplying the program code to the computer, specifically, a recording medium on which the program code is recorded are included in the scope of the present invention.

Examples of the recording medium on which such a program code is recorded include a floppy disk, a hard disk, an optical disk, a magneto-optical (MO) disk, a CD-ROM, a magnetic tape, a non-volatile memory card, and a ROM.

The scope of the present invention is not limited only to the case where the above-described computer controls various units according only to the supplied program code, thereby implementing the functions of the embodiments described above. The scope of the present invention further includes the case where the above-described program code operates together with an operating system (OS) running on the computer, or with other application software, thereby implementing the functions of the embodiments described above.

The scope of the present invention further includes the case where the supplied program code is stored in a memory of a function expansion board in a computer or in a memory of a function expansion unit connected to a computer, then a CPU or the like of the function expansion board or the function expansion unit executes a whole or part of the actual processing in accordance with instructions of the program code, thereby implementing the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-244132 filed Aug. 24, 2004, which is hereby incorporated by reference herein in its entirety.

What is claimed is:

1. A signature generating method comprising:
an input step of inputting content including dynamically changing information;
an obtaining step of obtaining at least one of an upper limit and a lower limit of the dynamically changing information;
a target-data generating step of generating, based on the at least one of the upper limit and the lower limit, target data; and
a signature generating step of generating signature data for the target-data by attaching a signature to the target data.

2. The signature generating method according to claim 1, wherein the dynamically changing information is content access control information.

3. The signature generating method according to claim 1, wherein the dynamically changing information is described in an extensible markup language.

4. The signature generating method according to claim 1, wherein the dynamically changing information includes numerical data that is a dynamically changing value and a range of the value.

5. The signature generating method according to claim 4, wherein the range of the value includes the upper limit and the lower limit.

6. The signature generating method according to claim 4, wherein the target-data generating step generates first information in which the numerical data is set to the upper limit and second information in which the numerical data is set to the lower limit.

7. The signature generating method according to claim 6, wherein the signature generating step generates signature data for the first information, for the second information, and for the content.

8. Computer-executable process steps for executing the method of claim 1.

9. A computer-readable storage medium for storing the computer-executable process steps of claim 8.

10. A signature verifying method comprising:
an input step of inputting content containing dynamically changing information and inputting signature data for the content;
an obtaining step of obtaining at least one of an upper limit and a lower limit of the dynamically changing information;
a target-data forming step of forming, from the at least one of the upper limit and the lower limit, target data; and
a signature verifying step of verifying the signature data based on the target data.

11. The signature verifying method according to claim 10, wherein the dynamically changing information is content access control information.

12. The signature verifying method according to claim 10, further comprising a range verifying step of verifying whether the dynamically changing information is included between the upper limit and the lower limit.

13. Computer-executable process steps for executing the method of claim 10.

14. A computer-readable storage medium for storing the computer-executable process steps of claim 13.

15. An information processing device comprising:
inputting means for inputting content containing dynamically changing information;
obtaining means for obtaining at least one of an upper limit and a lower limit of the dynamically changing information;
target-data generating means for generating, based on the at lease one of the upper limit and the lower limit, target data; and
signature generating means for generating signature data by attaching a signature to the target data.

16. The information processing device according to claim 15, wherein the dynamically changing information includes numerical data that is a dynamically changing value and a range of the value.

17. The information processing device according to claim 16, wherein the target-data generating means generates first information in which the numerical data is set to the upper limit and second information in which the numerical data is set to the lower limit.

18. The information processing device according to claim 17, wherein the signature generating means generates signature data for the first information, for the second information, and for the content.

19. An information processing device comprising:
input means for inputting content containing dynamically changing information and inputting signature data for the content;
obtaining means for obtaining at least an upper limit or a lower limit of the dynamically changing information;
target-data forming means for forming, from the upper limit or the lower limit, target data; and
signature verifying means for verifying the signature data based on the target data.

20. The information processing device according to claim 19, further comprising range verifying means for verifying whether the dynamically changing information is included between the upper limit and the lower limit.
